(19) United States
(12) Patent Application Publication
(10) Pub. No.: US 2025/0376062 A1
(43) Pub. Date: Dec. 11, 2025

(54) MODULAR DISPENSER

(71) Applicant: Caterpillar Inc., Peoria, IL (US)

(72) Inventors: Kishore Maruthi, Bengaluru (IN); Aravinth Manivannan, Bengaluru (IN)

(73) Assignee: Caterpillar Inc., Peoria, IL (US)

(21) Appl. No.: 18/737,695

(22) Filed: Jun. 7, 2024

(51) Int. Cl. B60L 53/62; B60L 53/20

(52) U.S. Cl. CPC B60L 53/62; B60L 53/20; B60L 2200/40; B60L 2210/10; B60L 2210/30

(57) ABSTRACT

A modular charge dispenser device includes a plurality of charger inputs to receive charge energy from a plurality of charger devices, wherein each charger device is configured to provide charge energy to charge a BEM; a charge dispenser bus; a multi-voltage converter configured to combine charge energy received via a multiple number of the charger inputs and output aggregated charge energy to the charge dispenser bus; and at least one output connector configured to output the aggregated charge energy from the charge dispenser bus.

### TECHNICAL FIELD

This document relates to electric powered work machines and in particular to a Megawatt class modular charge dispenser system for charging the energy source of battery electric machines.

### BACKGROUND

Powering a large moving work machine (e.g., a wheel loader, a mining truck, etc.) with an electric motor requires a large mobile electric energy source that can provide current of up to thousands of Amperes (Amps). An example of a mobile energy source is a battery system containing multiple strings of high-capacity batteries. The batteries in each string are connected in series, and the strings of batteries are connected in parallel to provide the high output power needed by the electric work machines. The mobile energy source needs to be recharged when the energy source nears depletion. Different battery electric machines may have different power needs and charging needs. Chinese Patent No. CN109412242A relates to an industrial robot charger control board having three power supplies. The power supply is output in two paths, one as the output of the working circuit and is connected to a circuit board, one serving as a control circuit connected with a power supply conversion board.

### SUMMARY OF THE INVENTION

Electric powered large moving work machines use large capacity battery systems that need charging, and the charging may need to be provided at a remote job site. However, the machines at the job site may have different charging needs. It would be advantageous for a single charging system to meet the different charging needs of the different types of machines. An example charging system includes a charge dispenser and multiple chargers. The system is modular in that multiple chargers can be connected to the one dispenser to provide flexibility in meeting the charging needs at the job site.

An example charge dispenser device includes a plurality of charger inputs to receive charge energy from a plurality of charger devices; a charge dispenser bus; a multi-voltage converter configured to combine charge energy received via a multiple number of the charger inputs and output aggregated charge energy to the charge dispenser bus; and at least one output connector configured to output the aggregated charge energy from the charge dispenser bus.

An example method of operating a charging system for a battery electric machine includes receiving, by a charge dispenser device of the charging system, an indication to start a charging session with the BEM; activating, by the charger dispenser device, a multiple number of charger devices connected to the charge dispenser device in response to the indication; receiving charge energy in parallel from the multiple charger devices at inputs of the charger dispenser device; and aggregating, by the charger dispenser device, the charge energy received in parallel and providing aggregated charge energy to the BEM.

### BRIEF DESCRIPTION OF THE DRAWINGS

FIG. 1 is an elevation view depicting an example work machine in accordance with this disclosure.

FIG. 2 is a diagram of an example charging system for battery electric work machines in accordance with this disclosure.

FIG. 3 is a block diagram of an example of portions of a charge dispenser device in accordance with this disclosure.

FIG. 4 is a block diagram of another example of portions of a charge dispenser device in accordance with this disclosure.

FIG. 5 is a block diagram of an example of a control system of a charger dispenser device in accordance with this disclosure.

FIG. 6 is a flow diagram of an example of a method of operating a charging system in accordance with this disclosure.

### DETAILED DESCRIPTION

Examples according to this disclosure are directed to devices, methods, and systems that improve charging of a rechargeable energy source of an electric work machine.

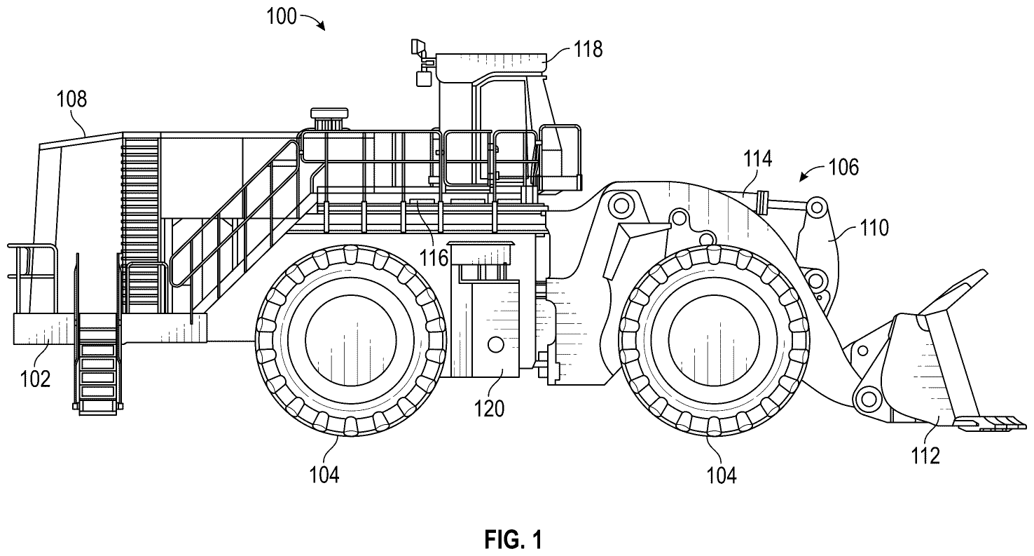

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. By further way of example, both operation by a remotely located operator and autonomous or robotic operation are contemplated. Machine 100 can be used to excavate a portion of a work site by actuating cylinders 114 to articulate bucket 112 via linkage assembly 110 to dig into and remove dirt, rock, sand, etc. from a portion of the work site and deposit this load in another location. Machine 100 can include a battery compartment connected to frame 102 and including a rechargeable battery system 120. Battery system 120 is electrically coupled to the one or more electric motors of the battery electric work machine 100.

The battery system 120 of different types of battery electric machines (BEMs) machines may have different charging needs. The battery system 120 may differ in the amount of charge needed to fully charge the battery system 120, the rate at which the battery system can be charged, the maximum rating of charging energy, etc.

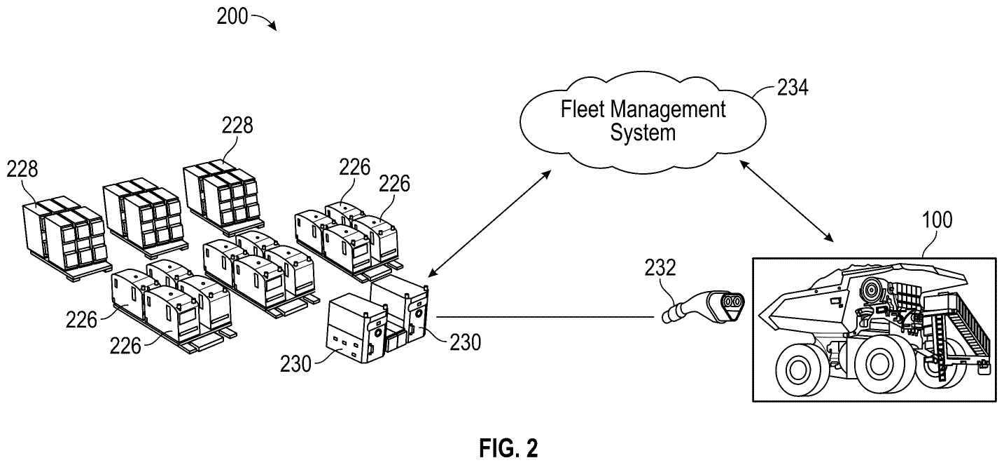

FIG. 2 is a diagram of an example of a charging system 200 for a battery electric machine 100. The system 200 includes multiple charger devices 226. Each charger device 226 is configured to provide high-capacity charge energy for charging a BEM 100. Each of the charger devices 226 can be coupled to one or more switch devices 228 that connect the charger device 226 to a grid, a generator set device, etc. The charging system 200 also includes at least one charge dispenser device 230. Multiple charger devices 226 are connected to one charge dispenser device 230 to provide charging energy in parallel to the charge dispenser device 230. The example system of FIG. 2 includes two charge dispensers and one to six charger devices 226 can be connected to each charge dispenser device 230 in the example.

The charge dispenser device 230 is connected to the BEM 100 by a charging cable 232 and plug. The charging cable 232 may be air-cooled or liquid-cooled depending on the capacity of the charging cable 232. A charge dispenser device 230 aggregates the charging energy from the charger devices 226 connected to it to provide the aggregated charging energy to the BEM 100 through the charging cable 232. This makes the charging system 200 modular and the charging energy produced from any of one to six chargers can be received in parallel and aggregated in the example system of FIG. 2. In some examples, more than six charger devices 226 can be connected to one charge dispenser device 230 and the charge from more than six charger devices can be aggregated by the changer dispenser device 230.

The BEMs 100 being charged may be automated and may operate without a human operator. Operation of the BEMs may be through a fleet management system 234. The fleet management system 234 may be implemented through one or more servers located at the remote site, or the one or more servers may be cloud-based. The fleet management system 234 manages the displacements of the automated BEMs 100 at the job site. The fleet management system 234 may communicate with the BEMs 100 and charge dispenser device 230 wirelessly (e.g., wireless WiFi). The fleet management system 234 sends specific instructions to the BEMs 100 to move them on specific lanes across the job site. When the fleet management system 234 determines that a BEM 100 needs charging, the fleet management system 234 may match a BEM 100 to a charge dispenser device 230 based on the charge dispenser's location, availability, and capacity. Upon connection to the BEM 100, the charge dispenser device 230 will automatically start a charging session. On completion, the charge dispenser device 230 may notify the fleet management system 234 that the BEM 100 can leave.

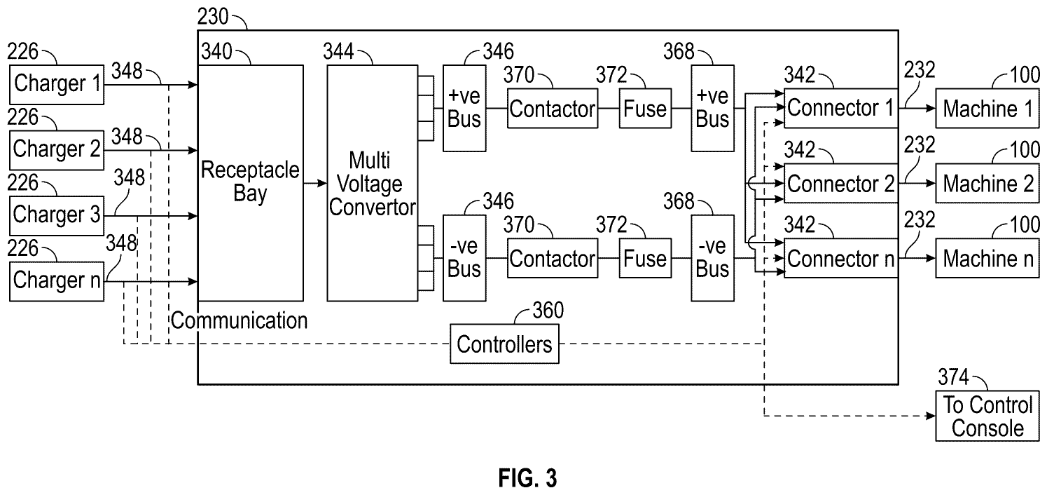

FIG. 3 is a block diagram of an example of portions of a modular charge dispenser device 230. The charge dispenser device 230 includes multiple charger input receptacles 340 to receive electrical energy from multiple charger devices 226 at the same time in parallel. In the example of FIG. 3, the charger devices 226 are numbered one through n, where n is a positive integer greater than three. The output of the charger devise 226 may have identical charging energy output, or the output of the charger devices 226 may differ in one or more of power, voltage, and current. The charger devices 226 are connected to the charger input receptacles 340 by charger cables 348. The charge dispenser device 230 includes an output connector 342 to connect to a charging cable 232 that is connectable to the BEM 100.

The charge dispenser device 230 may include a multi-voltage converter 344 and a charge dispenser bus 346. The example of FIG. 3 shows a positive (+ve) dispenser bus and a negative (−ve) dispenser bus. The multi-voltage converter 344 combines charge energy received via the charger input receptacles 340 and outputs variable aggregated charge energy to the charge dispenser bus 346. The multi-voltage converter 344 can combine charge energy that differs among the charger input receptacles 340 in one or more of power, current, and voltage.

The charge dispenser device 230 includes one or more controllers 360. The controllers include processing circuitry that includes one or more processors (e.g., microprocessors, application specific integrated circuits (ASICs), a programmable gate arrays (PGAs), or equivalent discrete or integrated logic circuitry). The controllers can include memory to store instructions performable by the processing circuitry. The instructions may be software or firmware instructions and the instructions configure the processing circuitry to perform the functions described for the processing circuitry. The controllers 360 can provide information to a control console 374 for a user as well as control the delivery of charging energy. The information may be sent to the control console 374 directly from the controllers 360 or via the fleet management system 234.

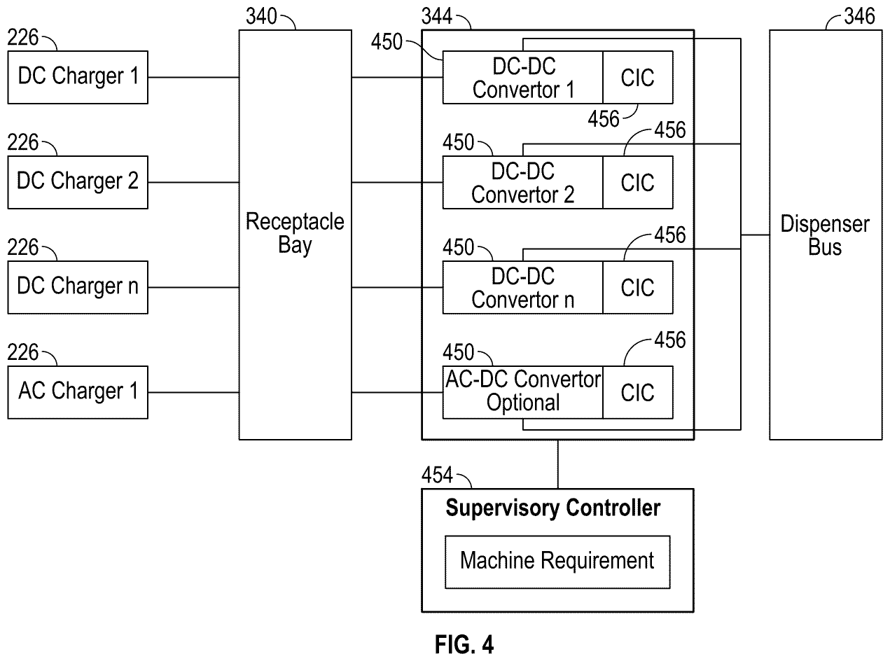

FIG. 4 is a block diagram of an example of portions of a charge dispenser device 230 including the multi-voltage converter 344. The multi-voltage converter 344 may include multiple direct-current-to-direct-current (DC-DC) converters 450. The DC-DC converters 350 may be buck-boost converters that steps the output DC voltage up or down from the voltage of the received charge energy. The multi-voltage converter 344 may include one or more alternating-current-to-direct-current (AC-DC) converters 452. The AC-DC converter 452 may receive AC charge energy from a charge device 226 that outputs AC charge energy.

The charge dispenser device 230 may include a supervisory controller 454. The supervisory controller 454 communicates information with the charger devices 226, the charge dispenser device 230, and the BEMs 100. The supervisory controller 454 receives the machine requirement for charging. This information may be received from the BEM 100 or from the fleet management system 234. The supervisory controller 454 also receives information on the charger devices 226 and their capacity. The supervisory controller 454 sets the load sharing among the charger devices 226 based on the machine requirement and the charger capacity.

The charge dispenser device 230 may include one or more charger interface controllers (CICs) 456. The example charge dispenser device 230 in FIG. 4 includes one CIC 456 for each of the power converters of the multi-voltage converter 344. In variations, the charge dispenser device 230 in FIG. 3 includes one CIC 456 to control all the power converters of the charge dispenser device 230. The CIC 456 receives information from the charger devices 226 (e.g., the power and voltage parameters of the charging energy from each charger device 226), and information from the supervisory controller 454 (e.g., one or more of the power, current, and voltage required for charging the machine). The CIC 456 identifies the charging protocol based on the information from the supervisory controller 454 and sets the output of the multi-voltage converter to the identified charging protocol.

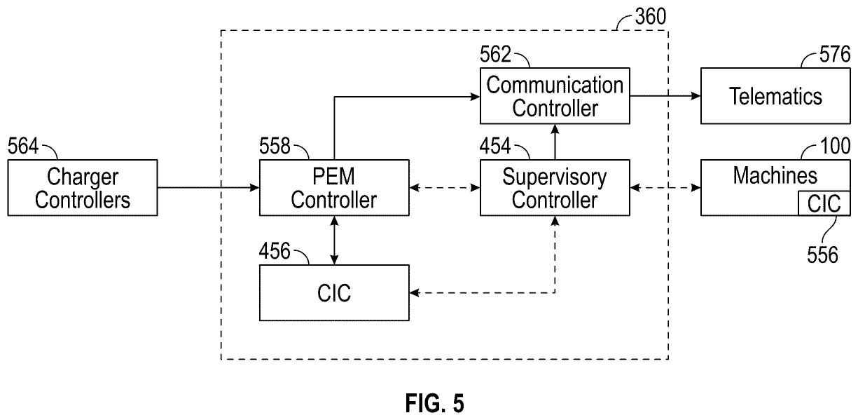

FIG. 5 is a block diagram of an example of control logic for a charge dispenser device 230. The charger dispenser device 230 can include a supervisory controller 454, one or more CICs 456, a communication controller 562, and may include one or more power electronic module (PEM) controllers 558. The supervisory controller 454 communicates with the charger controllers 564 of the charger devices and also communicates with the converters (450, 452) and the machines 100. The supervisory controller 454 sets the load sharing among the charger devices based on the machine charging requirements and charging capacity of the charger devices 226.

The CIC 456 receives the charging requirement from the machine 100 through the supervisory controller 454. The machine 100 can include a CIC 556 to communicate the charging requirement information to the supervisory controller 454. Using the charging requirement information received from the supervisory controller 454, the CIC 456 of the charge dispenser device 230 sets the charging protocol to conform to the machine charging protocol for the type of machine to be charged. The CIC 456 sends a command to the multi-voltage converter 344 to vary the voltage according to the machine charging requirement. The CIC 456 may also be an interface between different protocols of the charger cables 348. For example, the CIC 456 may translate between a combined charging system (CCS) cable and a Megawatt charging system (MCS) cable and vice versa. If present, the PEM controller 558 is included PEM modules of the power converters 450, 452 to provide another level of control in the power converters.

The CIC 556 of the machine 100 may send state of charge (SOC) information to the supervisory controller 454 during the charging session. The supervisory controller 454 may send a command to one or more of the charger controllers to change an output of at least one of the charger devices during the charging session according to the information of the SOC of the BEM 100, or may change the combination of charger devices 226 providing the charging energy.

The communication controller 562 may communicate wirelessly with the fleet management system 234. The communication controller 562 receives information from the supervisory controller 454 and PEM controller 558, and communicates the information to the user through telematics 576 of the charging system.

Returning to FIG. 3, the charge dispenser device 230 includes a safety bus 368. The safety bus 368 is coupled to the charge dispenser bus 346 by a contactor 370 and fuse 372. The contactor 370 and fuse 372 are rated for delivering the maximum current that can be provided by multiple charger devices 226. contactor 370 and fuse 372 prevent the power on the dispenser bus 346 from exceeding a power derating of the charge dispenser device 230.

In the example of FIG. 3, the charge dispenser device 230 includes multiple output connectors 342 that each can be connected to charging cables 232 to charge machines 100. Thus, more than one machine may be charged by one charge dispenser device 230, and the charge dispenser may be modular at both the input to aggregate energy from multiple charger devices 226 and at the output to charge multiple machines.

The modular charge dispenser is scalable and configurable for different types of BEMs to meet different power, current, and voltage ratings for the different BEMs.

### INDUSTRIAL APPLICABILITY

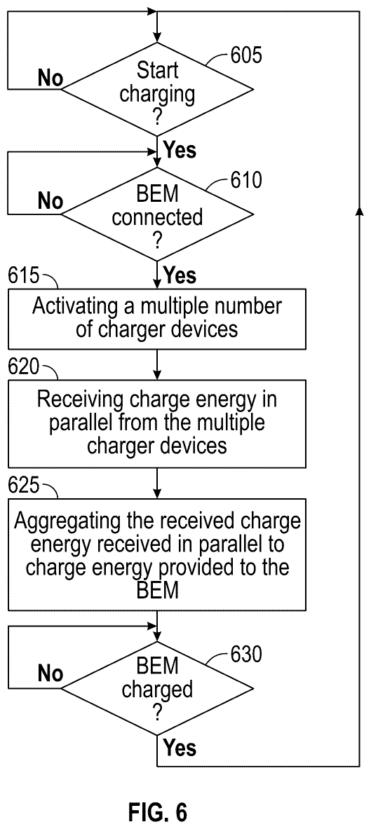

FIG. 6 is a flow diagram of an example of a method 600 of operating a charging system for a BEM such BEM 100 of FIG. 1. The charging system may be coupled to a power grid at a job site. The method 600 may be performed using a charging system having a modular charge dispenser such as the example charging system 200 of FIG. 2.

At block 605, the charge dispenser device 230 of the charging system 200 waits to receive an indication to start a charging session with a BEM. The indication may be an automatic command sent from the fleet management system 234 or a user of the fleet management system 234. At lock 610, the charge dispenser device 230 may wait for an indication that the charging cable 232 is connected before proceeding. The indication may be sent by the charging cable 232 or the BEM 100 when the charging cable 232 is connected.

At block 615, the charge dispenser device 230 activates or brings onboard two or more charger devices 226 to deliver the charge energy for the charging session in response to the indication to initiate the charging session. The number of charger devices 226 activated is based on the charge protocol for the BEM. Charging requirement information regarding the charge protocol may be received from a CIC 556 of the BEM 100 or a fleet controller of the fleet management system 234.

At block 620, the charge energy is received at inputs of the charge dispenser device 230 at the same time from the two or more charger devices 226 in parallel. The charge energy received from the charger devices 226 does need to be the same and may be different in power, voltage, or current.

At block 625, the charge energy received in parallel from the charger devices 226 is aggregated into charge energy, and the aggregated charge energy is provided to the BEM during the charging session. The charge energy may be aggregated using a multi-voltage DC-to-DC converter. The DC voltage of the aggregated charge energy may be different from the DC voltage of the charge energy provided by any of the charger devices 226. The DC voltage of the aggregated charge energy may be higher or lower than the DC voltage of the charge energy provided by the charger devices 226. The charge energy received from the charger devices 226 may be AC energy and the charge energy may be aggregated using a multi-voltage AC/DC converter. The charge energy received from the charger devices 226 may be a combination of DC energy and AC energy and the charge energy may be aggregated using a multi-voltage converter having a combination of AC-to-DC and DC-to-DC sub-converters.

The charge dispenser device 230 may include a communication controller 562 and the communication controller 562 may send status of the charging to the fleet management system 234 during the charging session. The charge dispenser device 230 may receive state of charge (SOC) information from the BEM 100. The charging protocol may include changing the charge energy based on the SOC of the battery system of the BEM. The charge dispenser device 230 may change an output of at least one of the charger devices during the charging session according to the information of the SOC of the BEM 100.

At block 630, the charge dispenser device 230 determines if charging the BEM is completed. The charge dispenser device 230 may determine that charging is complete from the SOC information or by a message from the CIC 556 of the BEM 100. The charge dispenser device 230 may inform the fleet management system when the charging session is completed.

In a subsequent charging session, a different number or different combination of the charger devices 226 may be activated by the charge dispenser device, and charging energy for the subsequent charging session may be different in one or more of power, current, and voltage from the previous charging session. The charging energy is scalable due to the modular configuration of multiple charger devices 226 and flexible to meet the power, voltage, and current ratings of different battery systems of BEMs.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A modular charge dispenser device to charge battery electric machines (BEMs), the device comprising:
a plurality of charger inputs to receive charge energy from a plurality of charger devices, wherein each charger device is configured to provide charge energy to charge a BEM;
a charge dispenser bus;
a multi-voltage converter configured to combine charge energy received via a multiple number of the charger inputs and output aggregated charge energy to the charge dispenser bus; and
at least one output connector configured to output the aggregated charge energy from the charge dispenser bus.

2. The device of claim 1, wherein the multi-voltage converter is configured to combine charge energy that differs between at least two of the charger inputs in one or more of power, current, and voltage.

3. The device of claim 1, wherein the multi-voltage converter includes a direct-current-to-direct-current (DC-DC) converter configured to produce the output aggregated charge energy with a variable DC output voltage.

4. The device of claim 1, wherein the multi-voltage converter includes an alternating-current-to-direct-current (AC-DC) converter configured to produce the output aggregated charge energy with a variable DC output voltage.

5. The device of claim 1, wherein the at least one output connector includes multiple output connectors, and the aggregated charge energy provided at the output connectors differs between two or more connectors in one or more of power, current, voltage.

6. The device of claim 1, including:
a safety bus; and
wherein the safety bus is coupled to the charge dispenser bus by a contactor and fuse.

7. The device of claim 1, including:
a controller configured to:
initiate a charging session with a BEM;
communicate a message to onboard charger devices to receive the charge energy via the multiple number of the charger inputs; and
communicate another message to the plurality of chargers to change charge energy output by at least one of the charger devices during the charging session.

8. The device of claim 1, including:
a controller configured to:
receive charge requirements of the BEM; and
set an output of the multi-voltage converter to produce the aggregated charge energy to meet the charge requirements.

9. The device of claim 8, wherein the controller is configured to:
identify a charging protocol of a charging cable connected to the at least one output connector; and
set the output of the multi-voltage converter to the identified charging protocol.

10. A method of operating a charging system for a battery electric machine (BEM), the method comprising:
receiving, by a charge dispenser device of the charging system, an indication to start a charging session with the BEM;
activating, by the charge dispenser device, a multiple number of charger devices connected to the charge dispenser device in response to the indication;
receiving charge energy in parallel from the multiple charger devices at inputs of the charger dispenser device; and
aggregating, by the charger dispenser device, the charge energy received in parallel and providing aggregated charge energy to the BEM.

11. The method of claim 10, wherein the aggregating the charge energy received in parallel includes:
receiving charge energy in parallel at the charge dispenser device that varies in one or more of current and voltage between charger devices; and
outputting the aggregated charge energy according to a voltage and current requirement of the BEM.

12. The method of claim 10, including:
receiving information of state of charge (SOC) of the BEM during the charging session; and
changing, by the charge dispenser device, an output of at least one of the charger devices during the charging session according to the information of the SOC of the BEM.

13. The method of claim 10, wherein the receiving charge energy in parallel from the multiple charger devices includes:
receiving first direct current (DC) charge energy at a first DC voltage from at least a first charger device; and
receiving second DC charge energy at a second DC voltage from at least a second charger device; and
wherein the aggregating the charge energy received in parallel includes:
aggregating the first and second DC charge energy to produce the aggregated charge energy using a multi-voltage converter of the charge dispenser device; and
wherein the aggregated charge energy includes a DC voltage different from one or both of the first DC voltage and the second DC voltage.

14. The method of claim 10, wherein the receiving charge energy in parallel from the multiple charger devices includes:
receiving direct current (DC) charge energy at a first DC voltage from at least a first charger device; and
receiving alternating current (AC) charge energy from at least a second charger device; and
wherein the aggregating the charge energy received in parallel includes aggregating the DC charge energy and AC charge energy to produce DC aggregated charge energy using a multi-voltage converter of the charge dispenser device.

15. The method of claim 10, wherein the aggregating the charge energy received in parallel includes:
producing the aggregated charge energy on a dispenser bus of the charge dispenser device; and
providing the aggregated charge energy from the dispenser bus to a first output connector of the charge dispenser device to charge the BEM and to a second output connector of the charge dispenser device to charge another BEM.

16. The method of claim 10, including:
receiving, by the charge dispenser device, charging requirement information from the BEM; and
outputting the aggregated charge energy to conform to the received charging requirement information from the BEM.

17. A charging system to charge battery electric machine (BEMs), the system comprising:
multiple charger devices, wherein each charger device is configured to provide charge energy to charge a BEM;
a modular charge dispenser device, including:
multiple charger input receptacles to connect to the multiple charger and receive charge energy in parallel from the multiple charger devices;
a multi-voltage converter configured to combine the charge energy received in parallel to an aggregated charge energy on a charge dispenser bus; and
at least one output connector configured to output the aggregated charge energy from the charge dispenser bus to charge the BEM.

18. The charging system of claim 17, wherein the charge dispenser device includes:
a supervisory controller configured to:
receive charging requirements for the BEM; and
configure the output of the multiple charger devices according to the charge requirements for the BEM.

19. The charging system of claim 18, wherein the supervisory controller is configured to:
receiving information of state of charge (SOC) of the BEM during a charging session; and
change the output of the multiple charger devices during the charging session according to the SOC information.

20. The charging system of claim 17, wherein the charge dispenser device includes:
a charger interface controller (CIC) configured to:
receive charging requirements for the BEM; and
configure the output of the multi-voltage converter according to the charge requirements for the BEM.
